(19) United States
(12) Patent Application Publication
(10) Pub. No.: US 2004/0124055 A1
(43) Pub. Date: Jul. 1, 2004

(54) Handle structure for luggage

(76) Inventor: Lien Ching Lu, Miaolihsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/331,466

(22) Filed: Dec. 31, 2002

(51) Int. Cl. A45C 13/30; A45C 13/00; B65D 25/28; A47J 45/00

(52) U.S. Cl. 190/115; 16/113.1

(57) ABSTRACT

An improved handle structure for luggage and particularly a handle structure that has a shock cushion effect and may extend the elevation of the handle of the luggage mainly includes a handle section, a control section, an adjusting section and a coupling section. The handle section has a bucking member running through a control slot of a coupling member of the control section. The bucking member has a concave section pressing the top end of a push rod. The push rod has a ram head pressing a sloped angle of a sliding member of the adjusting section, and an upper sloped angle and a lower sloped angle to move the coupling member upwards so that the anchor strut of the coupling member may be separated from or anchored in an anchor hole to extend the elevation of the handle. A torsional spring is provided with one foot wedged in a notch of a recess and another foot wedged in a lower casing of the adjusting section to alleviate the impact to user's hand holding the handle.

### BACKGROUND OF THE INVENTION

1. Field of the Invention

The invention relates to an improved handle structure for luggage and particularly a handle structure for extending the elevation of the handle of the luggage.

2. Description of the Prior Art

A conventional luggage such as the one shown in FIG. 10 generally has an extensible rod 91 located on one side of the luggage 9. The top end of the extensible rod 91 has a control handle 911, and the bottom end has a pair of casters 912 to enable users to haul the luggage 9. While such a construction allows users to select the height of the extensible rod 91 to suit their needs, in practical use, there are still drawbacks, notably:

1. On conventional luggage, the handle 911 is fixedly mounted on the extensible rod 91. The elevation of the handle can only be adjusted through the extensible rod. As users have different physical heights, and the general extensible rod 91 is designed to suit users of any physical height with a few anchor locations to form a few fixed elevations. The adjusted elevation of the extensible rod cannot fully mate the wide variations of users' heights. As a result, the extensible rod 91 could become too high or too low for some users. And inconveniences occur.

2. The general luggage 9 is generally moved by hauling through the casters 912. As the road or floor conditions are different and the loading of the luggage 9 also varies, the force required to tow and control the handle 911 also is different. The general luggage now available on the market do not have a shock cushion design. The impact occurred during the luggage travelling on the uneven road is totally absorbed by the handle 911, and user's hand has to bear all the impact force.

In view of the aforesaid disadvantages, it is clear that the stereotyped design of the conventional luggage cannot fully satisfy the versatile and multifunctional requirements of consumers these days. There is a growing demand to develop and introduce an innovative luggage handle to differentiate from the conventional ones, and to meet different requirements of consumers and to gain competitive edge on the market.

### SUMMARY OF THE INVENTION

Therefore the primary object of the invention is to provide an improved handle structure for luggage that can extend the elevation of the handle of the luggage.

Another object of the invention is to provide a handle structure for luggage that provides a shock cushion effect.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is an exploded view of the invention.

FIG. 2A is a perspective view of the upper shell of the invention.

FIG. 3 is a fragmentary perspective view of the adjusting section of the invention.

FIG. 4 is a perspective view of the upper shell of the handle section of the invention.

FIG. 5 is a sectional view of the invention showing the handle section, control section and adjusting section in a position before depressed.

FIG. 6 is a fragmentary sectional view of the invention showing the position of the torsional spring before depressed.

FIG. 7 is a sectional view of the invention showing the handle section, control section and adjusting section in a position after depressed.

FIG. 8 is a sectional view of the invention showing the handle section, control section and adjusting section in a position after the elevation of the handle is increased.

FIG. 9 is a fragmentary sectional view of the invention showing the position of the torsional spring after the elevation of the handle is increased.

FIG. 10 is a schematic view of a conventional luggage.

### DESCRIPTION OF THE PREFERRED EMBODIMENT

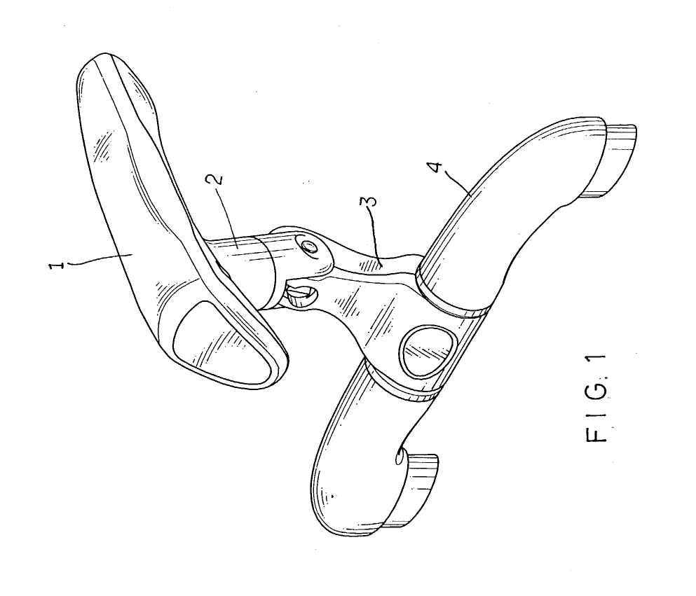

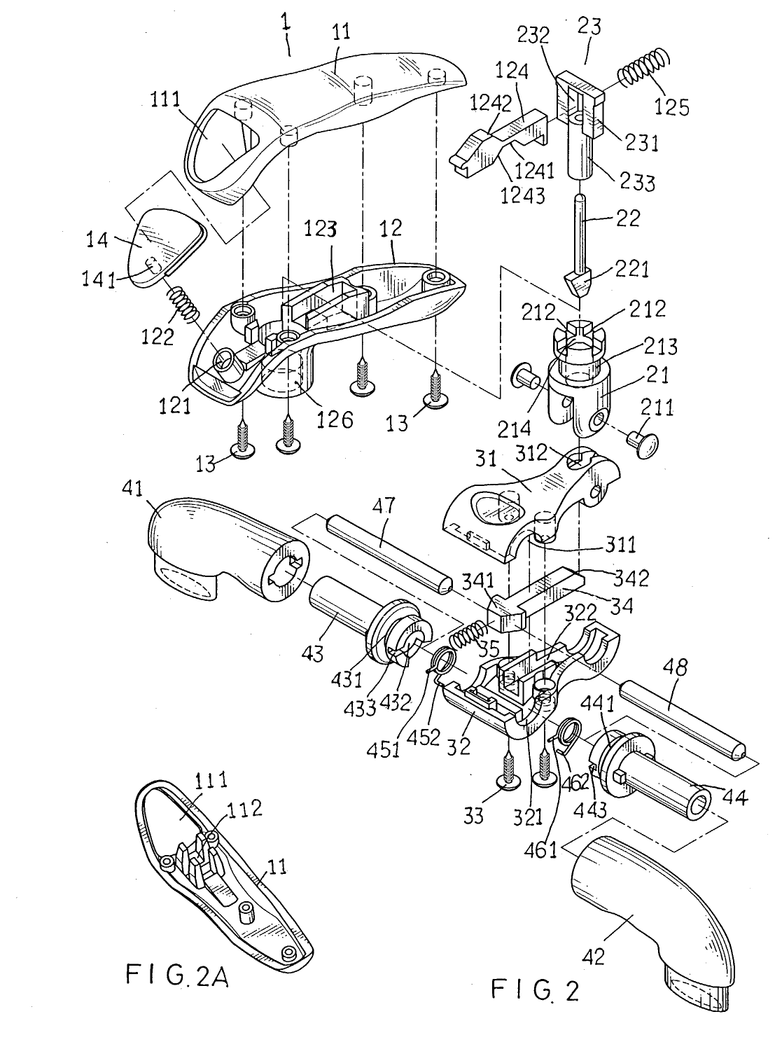

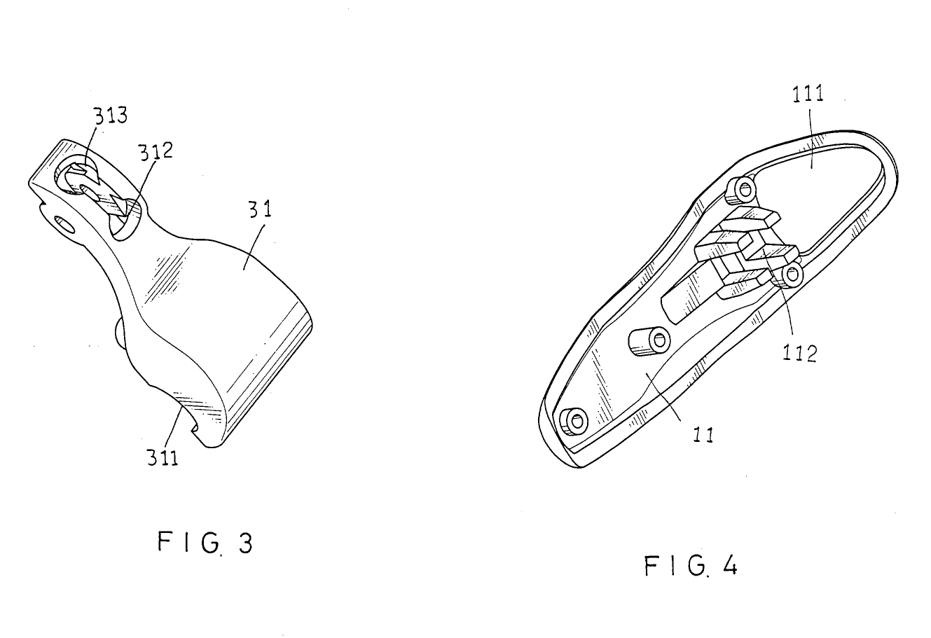

Referring to FIGS. 1 through 4, the invention mainly includes a handle section 1, a control section 2, an adjusting section 3 and a coupling section 4.

The handle section 1 includes an upper shell 11 and a lower shell 12 fastening together by means of screws 13. The upper shell 11 has an opening 111 located on one end thereof for housing a pushbutton 14. The lower shell 12 has a housing compartment 121 corresponding to the opening 111 of the upper shell 11 for holding a spring 122. The spring 122 has another end coupling with a strut 141 of the pushbutton 14. In addition, the upper shell 11 and the lower shell 12 have respectively a retaining trough 112 and 123 for holding a bucking member 124 and a spring 125. And the lower shell 12 has a cavity 126 formed on a lower side to engage with the control section 2. The bucking member 124 has a concave section 1241 to press the top end of a push rod 22 of the control section 2, and an upper sloped angle 1242 and a lower sloped angle 1243.

The control section 2 has a connecting member 21 which has a lower end pivotally engaged with the adjusting section 3 by means of a rivet 211 and an upper end forming a coupling trough 212. The connecting member 21 also has a neck 213 formed by plastic injection for housing in the cavity 126. The connecting member 21 has a hole 214 formed in the center to enable the push rod 22 to run through from the lower end to the upper end thereof. The push rod 22 has another end running through a coupling member 23. The coupling member 23 has an upper side forming a retaining block 231 for wedging in the coupling trough 212 of the connecting member 21. In the retaining block 231, there is a control slot 232 to receive the bucking member 124. The coupling member 23 further has a lower end forming an anchor strut 233.

The adjusting section 3 includes an upper casing 31 and a lower casing 32 fastening together by means of screws 33. One end of the upper and lower casings 31 and 32 has a coupling groove 311 and 321 corresponding to each other for coupling the coupling section 4. The lower casing 32 has a housing chamber 322 for holding and retaining a sliding member 34. The sliding member 34 has one end forming a bucking head 341. A spring 35 is provided to push the bucking head 341 to its original position. The sliding member 34 has another end apart from the bucking head 341 forming a sloped angle 342 which is in contact with a ram head 221 of the push rod 22. The upper casing 31 further has two anchor holes 312 and 313 communicating with each other through a slot.

The coupling section 4 includes a left coupling duct 41 and a right coupling duct 42 that have a bottom end connecting to an extensible tube 5 of the pulling bar. The left coupling duct 41 and the right coupling duct 42 house respectively therein a hollow left rod 43 and a right rod 44. The hollow left rod 43 and the right rod 44 have one end inserting into the left coupling duct 41 and the right coupling duct 42, and have keys and key ways to couple with each other for positioning. The hollow left rod 43 and the right rod 44 further house there in a left push bar 47 and a right push bar 48. The left rod 43 and the right rod 44 have respectively a coupling neck 431 and 441 to couple with the coupling groove 311 and 321 of the adjusting section 3, and a recess 432 and 442 for holding a torsional spring 45 and 46. The torsional springs 45 and 46 have one foot 451 and 461 wedged in a notch 433 and 443 of the recesses 432 and 442, and another foot 452 and 462 wedged in the lower casing 32 of the adjusting section 3.

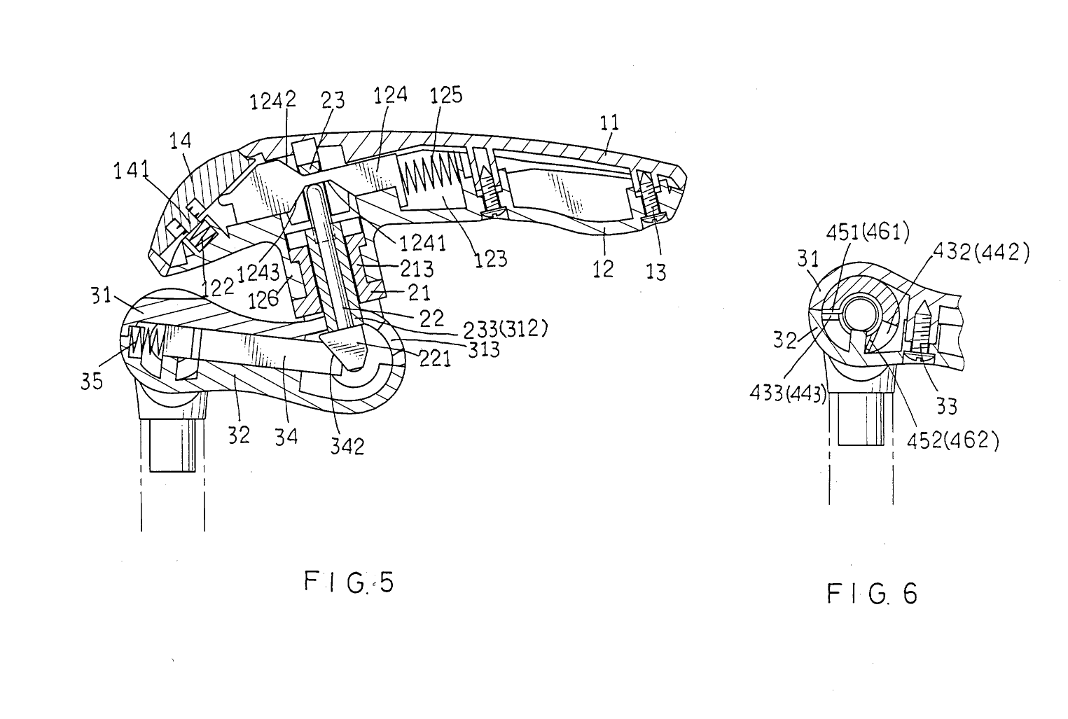

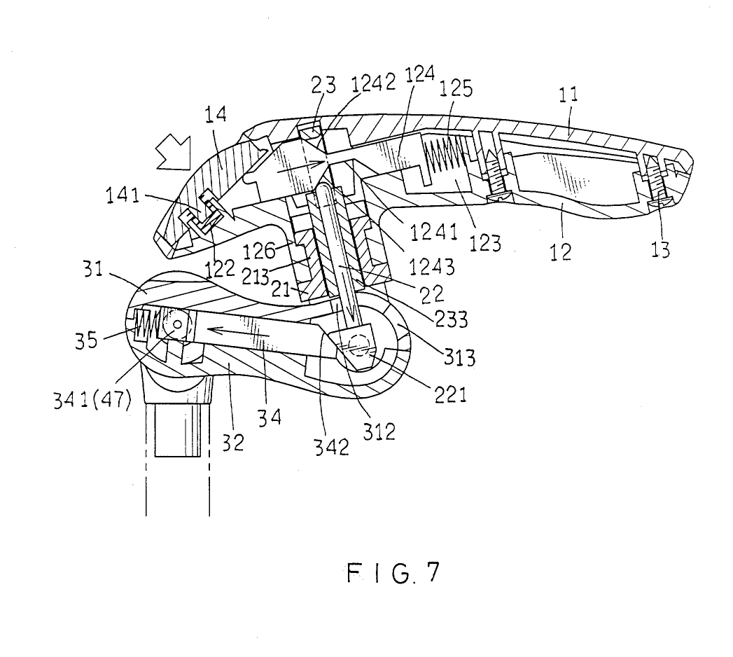

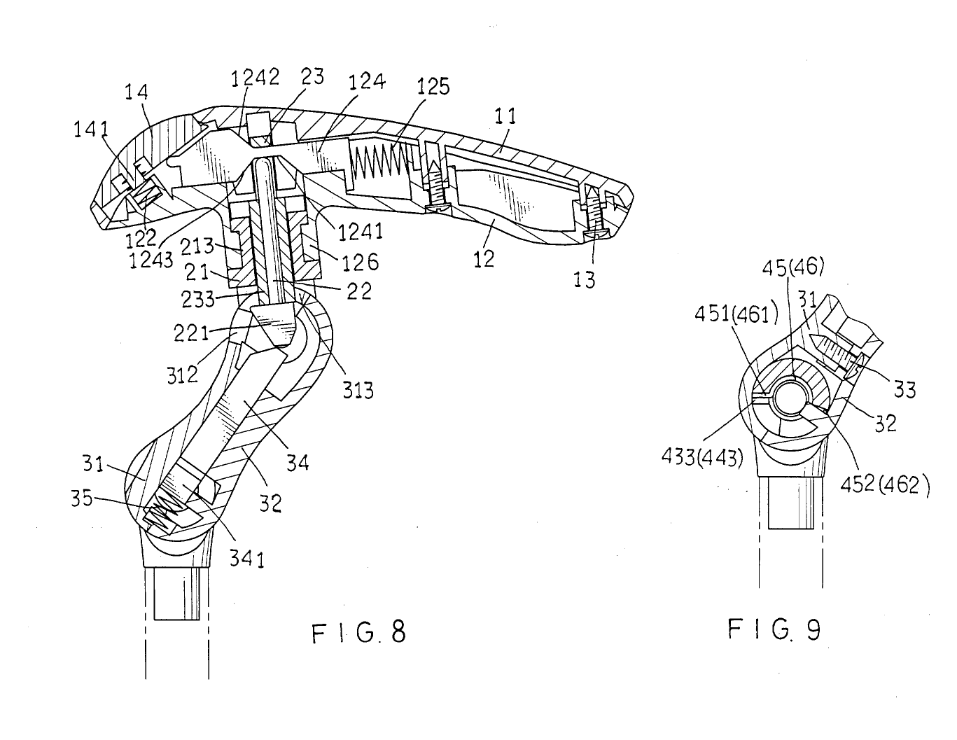

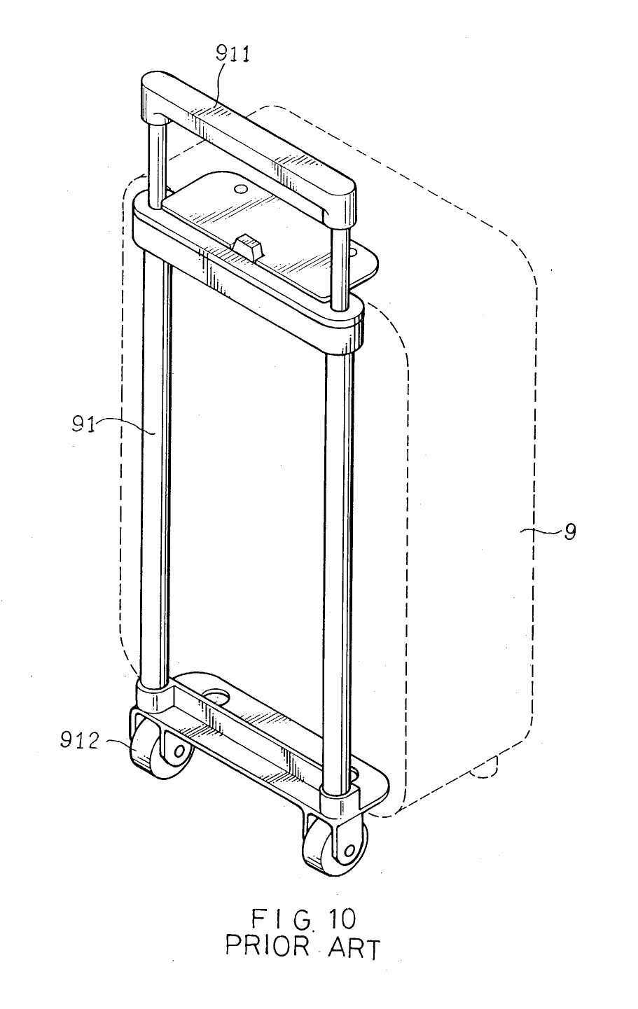

Refer to FIG. 5 for the invention before being depressed. The anchor strut 233 of the coupling member 23 is inserted into the anchor hole 312 of the adjusting section 3 to form an anchor condition. When there is a desire to extend the height of the handle section 1, referring to FIG. 7, first, depress the pushbutton 14 of the handle section 1, the pushbutton 14 drives the bucking member 124 forwards, and the lower sloped angle 1243 depresses the push rod 22 downwards, consequently the ram head 221 of the push rod 22 pushes the sliding member 34 forwards. Meanwhile, the upper sloped angle 1242 of the bucking member 124 pushes the coupling member 23 upwards and the anchor strut 233 is also moved upwards and escapes from the anchor hole 312. Thereby the connecting member 21 may be turned and moved to another anchor hole 313. Release the pushbutton 14, the bucking member 124 is pushed by the spring 125 to return to its original position prior to the depression. In the mean time, the anchor strut 233 of the coupling member 23 is inserted into the anchor hole 313 for anchoring, Thus the handle section 1 reaches a higher elevation (as shown in FIG. 8).

Referring to FIGS. 6 and 9, according to the invention, the torsional springs 45 and 46 have one foot 451 and 461 wedged in the notch 433 and 443 of the recesses 432 and 442, and another foot 452 and 462 wedged in the lower casing 32 of the adjusting section 3. Such a design enables the torsional springs 45 and 46 to absorb the impact occurred during the luggage is hauled on the uneven ground surface to alleviate the force and stress incurred to user's hand.

Thus when an user wants to adjust the height of the handle, he/she merely depresses the pushbutton 14, the upper sloped angle 1242 of the bucking member 124 pushes the coupling member 23, and the anchor strut 233 of the coupling member 23 may be moved away from the anchor hole 312, and the connecting member 21 may be turned to the position of another anchor hole 313 for anchoring. Thus the elevation of the handle section 1 is increased. Moreover, the design of the torsional springs 45 and 46 can alleviate the impact to the hand.

By means of the aforesaid construction the elevation of the handle may be extended and adjusted easily and a shock absorption effect also is provided. It is adaptable to any user. And it is a novel design different from the stereotyped design of the conventional luggage now on the market.

While the preferred embodiment of the invention has been set forth for the purpose of disclosure, modifications of the disclosed embodiment of the invention as well as other embodiment thereof may occur to those skilled in the art. Accordingly, the appended claims are intended to cover all embodiments which do not depart from the spirit and scope of the invention.

I claim:

1. An improved handle structure for a luggage comprising a handle section, a control section, an adjusting section and a coupling section, wherein:
the handle section includes an upper shell and a lower shell fastening together by means of screws, the upper shell having an opening located on one end thereof for housing a pushbutton, the lower shell having a housing compartment corresponding to the opening of the upper shell for holding a first spring, the first spring having another end coupling with a strut of the pushbutton, the upper shell and the lower shell having respectively a retaining trough for holding a bucking member and a second spring, the lower shell having a lower side forming a control trough and a cavity to engage with the control section, the bucking member having an upper sloped angle and a lower sloped angle;
the control section has a connecting member which has a lower end pivotally engaged with the adjusting section by means of a rivet and an upper end forming a coupling trough, the connecting member having a neck formed by plastic injection for housing in the cavity in a pivotal manner, the connecting member having a hole in the center thereof to allow a push rod to run through from a lower end to an upper end thereof, the push rod having another end running through a coupling member, the coupling member having an upper side forming a retaining block for wedging in the coupling trough of the connecting member, the retaining block having a control slot to receive the bucking member, the coupling member having an anchor strut located on a lower end thereof;
the adjusting section includes an upper casing and a lower casing fastening together by means of screws, the upper and the lower casings having respectively one end to form a corresponding coupling groove for coupling the coupling section, the lower casing having a housing chamber, the upper casing further having two anchor holes communicating with each other through a slot; and
the coupling section includes a left coupling duct and a right coupling duct for housing respectively a left rod and a right rod, the left rod and the right rod having respectively a coupling neck to couple with the coupling groove of the adjusting section, and a recess for holding a torsional spring, the torsional spring having one foot wedged in a notch formed in the recess and another foot wedged in the lower casing of the adjusting section.

2. The improved handle structure for a luggage of claim 1, wherein the housing chamber holds and retains a sliding member, the sliding member having one end forming a bucking head which is pressed by a second spring to its original position, the sliding member having another end apart from the bucking head to form a sloped angle in contact with a ram head of the push rod

3. The improved handle structure for a luggage of claim 1, wherein the left rod and the right rod left are hollow and have one end inserting respectively in the left coupling duct and the right coupling duct and are coupled by means of keys and key ways formed thereon.
